(19) United States
(12) Patent Application Publication
(10) Pub. No.: US 2006/0169214 A1
(43) Pub. Date: Aug. 3, 2006

(54) Animal waste receptacle

(76) Inventor: Brian Turkalo, Charlotte, NC (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/048,775

(22) Filed: Feb. 3, 2005

(51) Int. Cl. A01K 29/00

(52) U.S. Cl. 119/165

(57) ABSTRACT

An animal waste receptacle including a cabinet having a top panel with a slot that provides access into the cabinet. A bag is suspended beneath the slot by a bag dispenser so as to collect waste material passed into the slot from above. A litter box is positioned upon the top panel of the cabinet. The litter box has a chute that opens into the slot.

### FIELD OF THE INVENTION

The present invention relates generally to animal husbandry and, more particularly, to animal waste toilets and related devices.

### BACKGROUND OF THE INVENTION

Clean litter boxes are favored by most cats. As all cat owners know, the tasks of manually scooping waste from clean litter and, then, hauling the waste from one's living space must be performed every few days. If one owns several cats, litter box cleaning can be a daily event. Sometimes it can seem as if more time is devoted to attending to a cat's excretory functions than a cat's more endearing behaviors.

In an effort to reduce time spent raking litter boxes, some have proposed self-cleaning litter boxes that automatically sift waste from clean litter. Unfortunately, these items are complicated and costly in their construction and require a source of electrical current. Furthermore, some of these litter boxes have been known to trap and injure the cats that use them. A need, therefore, exists for an inexpensive means for quickly disposing of cat waste so that a user has more time to devote to more enjoyable things in life like interacting with a pet cat.

### SUMMARY OF THE INVENTION

In light of the problems associated with the cleaning of known litter boxes, it is a principal object of the invention to provide an animal waste receptacle that has a large storage capacity and can hold several days' worth of waste raked from a litter box that comprises part of the receptacle. Odors are sealed within the receptacle so that it might be emptied as infrequently as once every other week.

It is a further object of the invention to provide an animal waste receptacle of the type described that dispenses waste bagging material. Thus, should the receptacle become filled, a user need not hunt for bags or other containers. The receptacle is always ready for use.

It is another object of the invention to provide an animal waste receptacle of the type described that can incorporate, if desired, a self-cleaning litter box. With a self-cleaning litter box, a user need not make any contact with animal waste during use of the receptacle.

Still another object of the invention is to provide an animal waste receptacle that elevates a litter box from the floor so as to eliminate a common tripping hazard in many homes. Further, from an elevated position, a user can rake the litter box without stooping.

It is an object of the invention to provide improved elements and arrangements thereof in an animal waste receptacle for the purposes described that is lightweight in construction, inexpensive to manufacture, easy to clean, and dependable in use.

Briefly, the waste receptacle in accordance with this invention achieves the intended objects by featuring a cabinet having a top panel with a slot and a cutout remote from the slot. A bag is suspended beneath the slot by a bag dispenser so as to collect waste material passed into the slot from above. The bag dispenser has a dispensing box releasably secured to the top panel that contains an accordioned tube of plastic sheeting that can be formed into bags by tying knots in the tube at chosen points along its length. A litter box is positioned upon the top panel and has a chute that opens into the slot and a well for snug positioning in the cutout. A flap, pivotally secured to the litter box, selectively closes the chute.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is an exploded perspective view of an animal waste receptacle in accordance with the present invention.

FIG. 2 is a side view of the animal waste receptacle of FIG. 1.

FIG. 3 is a cross-sectional view of a bag dispenser forming part of the animal waste receptacle.

FIG. 4 is a top view of the animal waste receptacle.

FIG. 5 is a front view of the animal waste receptacle with portions broken away to reveal details thereof.

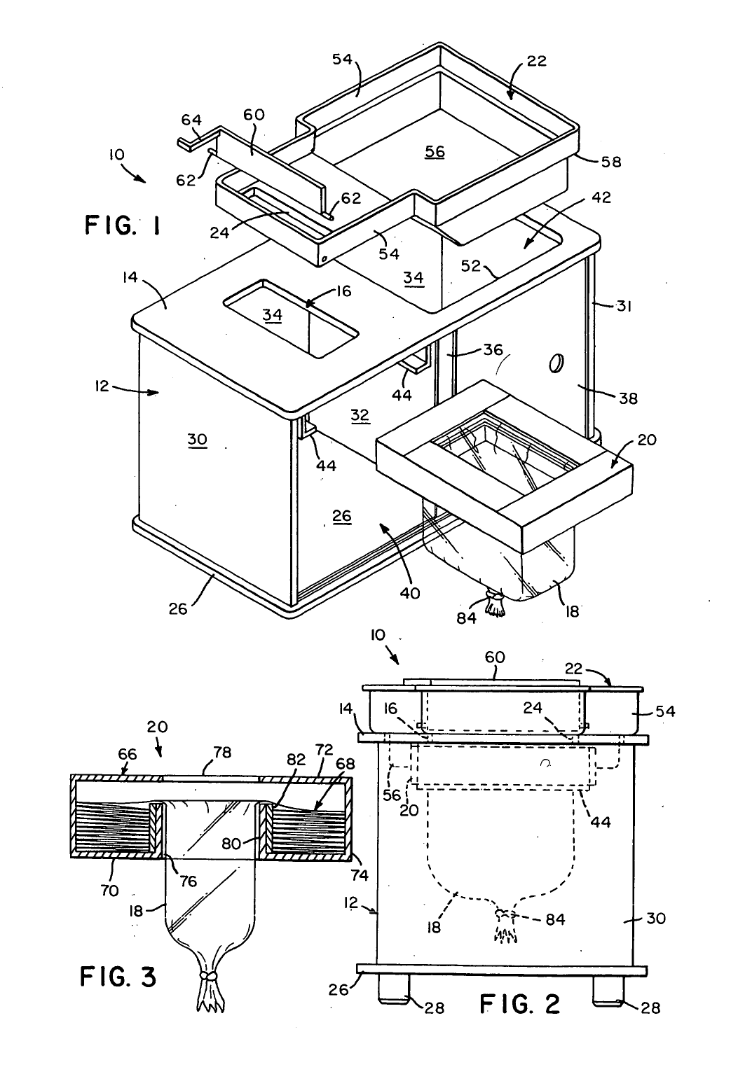

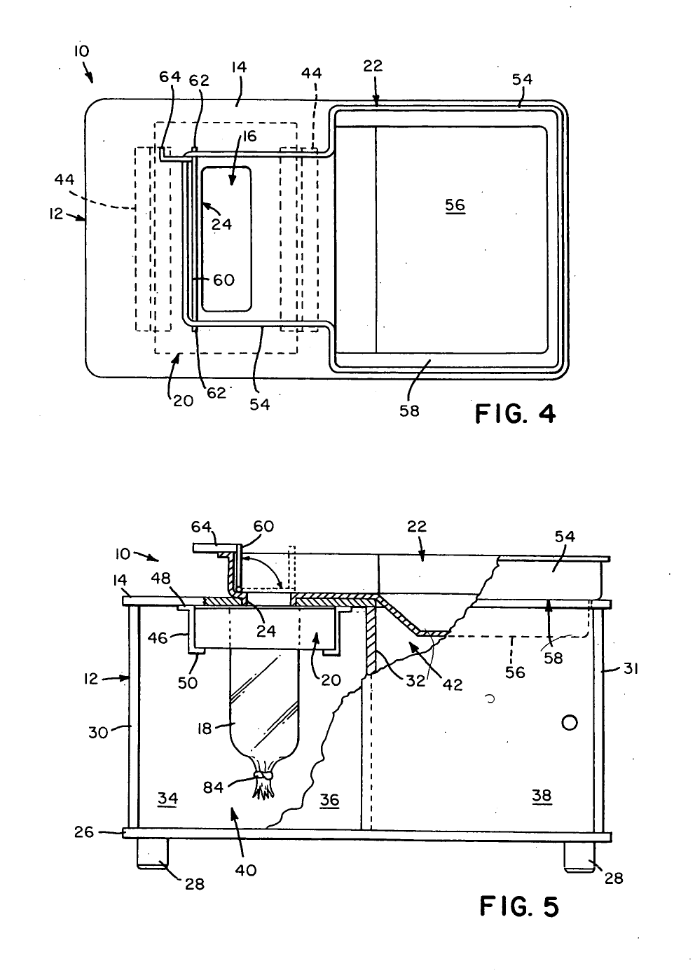

Similar reference characters denote corresponding features consistently throughout the accompanying drawings.

### DETAILED DESCRIPTION OF THE PREFERRED EMBODIMENT

Referring now to the FIGS., an animal waste receptacle in accordance with the present invention is shown at 10. Receptacle 10 includes a cabinet 12 having a top panel 14 with a slot 16 that provides access into cabinet 10. An open bag 18 is suspended beneath slot 16 by a bag dispenser 20 so as to collect waste material passed into slot 16 from above. A litter box 22 is positioned upon top panel 14 of cabinet 12 and has a chute 24 that opens into slot 16. In use, waste raked from litter box 22 into chute 24 passes through slot 16 into bag 18 for easy collection and disposal.

Cabinet 12 is a rectangular box formed of durable materials. Cabinet 12 includes a bottom panel 26 supported above a floor by a plurality of legs 28. A pair of side panels 30 and 31 extends upwardly from opposite ends of bottom panel 26 and a medial panel 32 extends upwardly from the midpoint of bottom panel 26 to support top panel 14. The back of cabinet 12 is closed by a rear panel 34 that is secured to top, bottom, side, and medial panels 14, 26, 30 and 32. A pair of sliding doors 36 and 38 closes the front of cabinet 12 and provides selective access to interior spaces 40 and 42 on opposite sides of medial panel 32.

Slot 16 penetrates top panel 14 about midway between side panel 30 and medial panel 32. On opposite sides of slot 16, a pair of retaining brackets 44 is affixed to top panel 14 within interior space 40. Each of the brackets 44 includes: a vertical web 46 that extends downwardly from top panel 14, a top plate 48 that extends outwardly from the top of the web 46 for attachment to top panel 14 by threaded fasteners (not shown) or other suitable means, and a bottom plate 50 that extends inwardly toward slot 16 from the bottom of web 46. Together, bottom plates 50 of both brackets 44 define a shelf upon which bag dispenser 20 can be removably positioned.

A cutout 52 is provided in top panel 14 between side panel 31 and medial panel 32 for recessing litter box 22 into cabinet 12. As shown, cutout 52 is substantially larger than slot 16, having a length that is slightly less than the distance between side panel 31 and medial panel 32 and having a width that is slightly less than the distance between rear panel 34 and door 38.

The dimensions of cabinet 12 and its features are largely a matter of design choice. Cabinet 12 has a height capable of supporting litter box 22 at an elevation that is not so high that a cat cannot easily jump upon litter box 22 yet not so low that a human user must stoop excessively to rake material from litter box 22. The length and width of cabinet 12 are sufficient to support a litter box 22 of convenient size for a cat.

Litter box 22 includes an open-topped trough 54 with chute 24 at one of its ends and a litter-retaining well 56 at the other of its ends. Chute 24 projects downwardly from trough 54 in the manner of a funnel to direct waste material through slot 16 and into bag 18. Well 56, however, projects downwardly from trough 54 to form a basin below top panel 14 for the containment of absorbent cat litter (not shown). Preferably, the sides of chute 24 and well 56 are spaced from the sides of trough 54 so as to form a peripheral lip or flange 58 that serves as a stop to prevent litter box 22 from tipping and falling into cabinet 12. To prevent litter box 22 from moving about once placed atop cabinet 12, chute 24 and well 56 are dimensioned to snugly fit within slot 16 and cutout 52.

Chute 24 can be selectively closed by means of a pivoting flap 60 to prevent odors from escaping from bag 18. Flap 60 is secured to litter box 22 by a pair of pivot pins 62 at its bottom that are journaled in trough 54 on opposite sides of chute 24. An elongated handle 64 extending from the top of flap 60 permits flap 60 to be easily raised and lowered without need to place the hands of a user within litter box 22.

Bag dispenser 20 comprises a cardboard dispensing box 66 containing an accordioned tube of plastic sheeting 68. Box 66 is dimensioned for support by brackets 44 and has a bottom wall 70 and a top wall 72 held together by an outer wall 74. Bottom wall 70 and top wall 72 are provided with axially aligned apertures 76 and 78. An inner wall 80 extends upwardly from the periphery of aperture 76 about half way to top wall 72 thereby forming a circular trough within which sheeting tube 68 is retained. Inner wall 80 is stiffened and reinforced by a cardboard band 82 that is positioned within the circular trough to snugly encircle inner wall 80.

To form bag 18, the free end of sheeting tube 68 is first pulled from the space formed between top wall 72 and inner wall 80. Then, the free end of tube 68 is pulled downwardly through aperture 76 so that it can just touch bottom wall 26. Finally, a knot 84 is tied in the free end of tube 68 to prevent the escape of material deposited therein via aperture 78 in top wall 72 of box 66. Should bag 18 become full, it is easily removed from cabinet 12 by cutting tube 68 at a convenient distance from knot 84 with scissors. The top of bag 18, now severed from box 66, can be knotted or tied closed as a user may desire.

Once bag 18 is formed, waste is easily moved from litter box 22 into bag 18. To do this, flap 60 is first opened to expose chute 24 by a light upward pressure on handle 64. Next, waste is raked from well 56 across flange 58 and into chute 24. After gravity pulls the waste to the bottom of bag 18 suspended beneath chute 24, handle 64 is released to trap odors within bag 18. The entire process requires just a few seconds to complete.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

I claim:

1. An animal waste receptacle, comprising:
a cabinet having a top panel with a slot that provides access into said cabinet;
a bag being suspended beneath said slot by a bag dispenser so as to collect waste material passed into said slot from above; and,
a litter box being positioned upon said top panel of said cabinet and said litter box having a chute that opens into said slot.

2. The waste receptacle according to claim 1 wherein said cabinet includes:
a bottom panel having opposite ends and being supported by a plurality of legs;
a pair of side panels extending upwardly from said opposite ends of said bottom panel;
a medial panel extending upwardly from said bottom panel between said side panels;
said top panel being supported by said side panels and said medial panel;
a rear panel being secured about its periphery to said bottom panel, said side panels and said top panel; and,
a pair of doors being slidably engaged with said bottom panel and said top panel for selectively closing the front of said cabinet.

3. The waste receptacle according to claim 1 further comprising a pair of retaining brackets being affixed to said top panel within said cabinet for supporting said bag dispenser, each of said retaining brackets including:
a vertical web extending downwardly from said top panel;
a top plate extending away from said slot at the top of said web; and
a bottom plate extending toward said slot from the bottom of said web.

4. The waste receptacle according to claim 1 wherein said top panel of said cabinet includes a cutout remote from said slot and said litter box includes:
an open-topped trough having opposite ends and sides and also having a chute at one of said ends and a litter-retaining well at the other of said ends;
said chute projecting downwardly from said trough into said slot in said top panel;
said well projecting downwardly from said trough into said cutout in said top panel; and,
said chute and said well being spaced from said sides and ends of said trough so as to form a peripheral flange serving as a stop to prevent said litter box from moving about.

5. The waste receptacle according to claim 4 further comprising a flap secured to said litter box by a pair of pivot pins for selectively closing said chute and a handle extending from said flap that permits said flap to be raised and lowered.

6. The waste receptacle according to claim 3 wherein said bag dispenser includes:
a box being slidably positioned upon said retaining brackets, said box having:
a bottom wall and a top wall held in opposition by an outer wall, said bottom wall and said top wall being provided with axially aligned apertures;
an inner wall extending upwardly from the periphery of said aperture in said bottom wall about half way to said top wall; and,
an accordioned tube of plastic sheeting being positioned within said box upon said bottom wall.

7. An animal waste receptacle, comprising:
a cabinet having a top panel with a slot and a cutout remote from said slot that provide access into said cabinet;
a bag being suspended beneath said slot by a bag dispenser so as to collect waste material passed into said slot from above, said bag dispenser including:
a dispensing box being releasably secured to said top panel, said dispensing box having:
a bottom wall and a top wall held in opposition by an outer wall, said bottom wall and said top wall being provided with axially aligned apertures;
an inner wall extending upwardly from the periphery of said aperture in said bottom wall about half way to said top wall; and,
an accordioned tube of plastic sheeting being positioned within said dispensing box upon said bottom wall;
a litter box being positioned upon said top panel of said cabinet and said litter box having a chute that opens into said slot, said litter box including:
an open-topped trough having opposite ends and sides and also having a chute at one of said ends and a litter-retaining well at the other of said ends;
said chute projecting downwardly from said trough into said slot in said top panel;
said well projecting downwardly from said trough into said cutout in said top panel; and,
said chute and said well being spaced from said sides and ends of said trough so as to form a peripheral flange serving as a stop to prevent said litter box from moving about.
